(19) United States
(12) Patent Application Publication
(10) Pub. No.: US 2025/0197173 A1
(43) Pub. Date: Jun. 19, 2025

(54) METHOD AND SYSTEM FOR QUALITY ASSESSMENT OF OBJECTS IN AN INDUSTRIAL ENVIRONMENT

(71) Applicant: Siemens Aktiengesellschaft, München (DE)

(72) Inventors: Manish Chowdhury, Guwahati, Assam (IN); Renith Richardson, Bangalore, Karnataka (IN)

(21) Appl. No.: 18/849,888

(22) PCT Filed: Mar. 31, 2022
(86) PCT No.: PCT/EP2022/058659

§ 371 Date: Sep. 23, 2024

(51) Int. Cl. B66C 13/48; B66C 13/46; G06T 5/70; G06T 5/90; G06T 7/00; G06T 7/194; G06V 20/70

(52) U.S. Cl. CPC B66C 13/48; B66C 13/46; G06T 5/70; G06T 5/90; G06T 7/0008; G06T 7/194; G06V 20/70; G06T 2207/20084; G06T 2207/30108

(57) ABSTRACT

A method for managing a crane system capable of handling an object using an artificial neural network, a crane system, a method for training the artificial neural network, and a computer program product code are provided. The method includes generating an image data stream based on multiple images of the object captured by cameras of the crane system, analyzing the image data stream by employing a computing unit of the crane system using the artificial neural network trained for identifying markers from the image data stream, determining, by the computing unit, object properties associated with the object based on the analysis of the image data stream, wherein the object properties comprise at least a quality of the object, and automatically operating the crane system for handling the object based on the object properties.

### CROSS-REFERENCE TO RELATED APPLICATIONS

This application is a national stage of PCT Application No. PCT/EP2022/058659, having a filing date of Mar. 31, 2022, the entire contents of which is hereby incorporated by reference.

### FIELD OF TECHNOLOGY

The following disclosure relates to a method, a system, and a computer program product used for assessing quality of one or more objects in an industrial environment. More particularly, the present disclosure relates to assessing quality of objects using a combination of image processing techniques and artificial intelligence methods in conjunction with analytical methods.

### BACKGROUND

Rapid digitalization of industries is bringing a pivotal change in the current industrial practices. For example, categorizing of an object in an industry is typically performed to certify that the object and/or associated product meets the defined grade and quality requirements.

Especially in some industrial environments such as container terminals, loading processes with the help of cranes are increasingly popular and automated, i.e., without manual intervention by operators. In such cases, quality sorting including picking and dropping of objects such as coils by cranes requires a human intervention for assessing quality of objects and thereafter, picking, dropping, and categorized loading of the objects by cranes. Moreover, to ensure the safety of loading operations, especially for automated cranes, there is a great need for safety systems and protective devices that monitor the lanes in which the cranes are deployed or the environment during crane movement in order to avoid collisions with objects or persons in the proximity of the crane.

Typically, quality sorting is performed by trained human inspectors who assess the object by looking for a specific quality attribute. Such inspection process usually involves further testing using laboratories, and is therefore time consuming. Moreover, such human driven object quality inspection requires other equipment for example, a scale for estimating the current weight of object, a laboratory for measuring traces and parameters such as humidity in the object, etc.

Furthermore, the conventional quality inspection processes are not only subject to inconsistencies due to heavy reliance on human expertise but also expensive due to manual labor costs, and cumbersome considering industrial scale and huge volumes of objects to be inspected.

To address the aforementioned problems, machine learning techniques have been suggested and/or used for identifying defects in an object based on the object images, however the training time for such machine learning techniques is quite long. Typically, longer training times are known to increase the CO2 emissions from a machine employed in the training.

Furthermore, existing methods for identifying industrial object defects use an unsupervised learning approach wherein a surface color and a surface texture of the object acts as a primary parameter in the object image to predict defects associated therewith. Image segmentation plays a central role in identifying defects from an image. Image segmentation includes classifying pixels of the image into random number of clusters. However, selecting the number of cluster labels in an unsupervised image segmentation is a challenging task and uses up processing power and memory of the system thus, rendering it resource intensive.

Accordingly, it is an object of the present disclosure to provide a quality assessment system, a device and a method for assessing quality of an object in an industrial environment, that employ a supervised machine learning approach in conjunction with a select set of image processing techniques to identify quality of an object in an industrial environment based on the object image(s) in a time and cost effective manner while ensuring that the associated training time is kept minimal.

Disclosed herein is a crane system capable of handling an object. According to an embodiment, the crane system is an overhead crane deployable in an industrial environment. As used herein, the term “object” refers to an industrial object, for example, metal coils that are heavy and therefore require a crane system to be moved from one place to other.

The crane system comprises cameras positioned so as to capture a plurality of images of the object. The cameras comprise, for example, high definition light detection and ranging (LIDAR) cameras capable of capturing high definition real time images of the object. According to an embodiment, the crane system comprises three cameras mounted at predefined locations on the crane system. According to this embodiment, a first camera is arranged at a first end of a gantry of the crane system; a second camera is arranged at a second end of the gantry; and a third camera is arranged in proximity of a hoist on the gantry. In embodiments, each of these cameras is aligned for a predefined angle of capture with respect to the object and/or the hoist that is capable of moving the object. In embodiments, the angle of capture is defined based on a size and an orientation of the crane system and the area in which the crane system is deployed.

It would be appreciated by a person skilled in the conventional art that the two cameras positioned at either end of the gantry have similar functionality and are could easily replace one another. However, having both of these provides the required redundancy in cases where a field of view of one of the cameras is obstructed due to unforeseen circumstances.

The crane system comprises a computing unit having an artificial neural network. The computing unit receives, from the cameras, the images of the object, for example in real time in embodiments. In embodiments, the artificial neural network is stored on the computing unit. The artificial neural network is a trained artificial neural network, for example, trained to analyze images for recognizing patterns in the images. For example, the artificial neural network is a Convolutional Neural Network (CNN) that may include a Pyramid Scene Parsing network (PSPnet) with CNN, so as to capture both local and global information along with spatial information of an image, thereby enabling the crane system handling the object to determine not only defects in the object but also remaining useful life of the object. It would be appreciated by a person skilled in the art that the remaining useful life factor is subject to the type of object. For example, the remaining useful life may be more relevant for perishable objects being handled by the crane system, if any as compared with non-perishable objects.

The crane system includes a control unit. The control unit may be in communication with a drive system of the crane system, such that the control unit either directly or via the drive system causes physical movement of the cameras and/or the crane system.

According to one embodiment, the control unit moves the crane system and thereby, causes the physical movement of the cameras. According to this embodiment, the cameras are triggered by the movement of the crane system to start capturing the images of the object.

According to another embodiment, the control unit, independently causes movement of the cameras and thereby, triggering them to capture the images of the object.

In embodiments, the cameras capture the images of the object, along a longitudinal axis A-A′ of gantry tracks. The control unit may move one of the cameras arranged in proximity of the hoist on the gantry along a lateral axis perpendicular to the longitudinal axis. According to this embodiment, the computing unit is operably coupled to the control unit, for example, via a wired or a wireless communication network including, the internet, an intranet, a wired network, a wireless network, and/or any other suitable communication network capable of establishing a strong and secure communication. According to another embodiment, the control unit may include the computing unit as a part or as a whole. According to yet another embodiment, the computing unit may include the control unit as a part or as a whole.

According to an embodiment, the computing unit receives images from the cameras.

According to this embodiment, the computing unit generates an image data stream from the images by performing pre-processing of the images including but not limited to reducing noise in the images, enhancing contrast of the images, for example, by applying a median filter followed by histogram equalization followed by another median filter, and/or stitching the images together to form an image data stream. According to this embodiment, the computing unit determines from the images, a foreground associated with object, for example, by performing background subtraction. According to this embodiment, the computing unit annotates the foreground(s) from the images. According to another embodiment, the computing unit receives an image data stream generated based on the images captured by the cameras.

The computing unit analyzes the image data stream generated based on the images using an artificial neural network. The computing unit determines one or more object properties associated with the object based on the analysis of the image data stream. The object properties comprise at least a quality of the object. The quality of the object being defined based on presence of defect(s) in the object. The object properties may also comprise a position, an orientation, a dimension of the object, a type of the object, a surface of the object, an edge of the object, etc.

The computing unit detects, from the image data stream, presence of one or more abnormalities in the object. The abnormalities include, for example, a defect in the object, a human in close proximity of the object, etc. The computing unit segments the images based on the artificial neural network and identifies markers in the object, wherein a distance between the markers corresponds to an extent of the abnormality in the object.

The artificial neural network comprises labelled images based on which the computing unit segments the images into multiple areas, that is, pixel clusters based on color, contours, etc. In embodiments, the computing unit determines a distance between the markers. The computing unit based on the distance between the markers derives primary object properties comprising, for example, a length, a height, an area, etc., of the object. Based on these primary object properties, the computing unit derives using the trained artificial neural network, secondary object properties comprising, for example, an approximate weight, a remaining useful life, a size, and a defect area of the object.

According to an embodiment, the computing unit detects from the image data stream, presence of a human in proximity of the object. The computing unit segments the images based on the artificial neural network and identifies markers in the images corresponding to humans, wherein a distance between the markers corresponds to a proximity of the human with respect to the object.

The computing unit using the trained artificial neural network thus determines based on the distance between the markers and the segmented images, presence of the abnormalities.

The control unit automatically operates a hoist of the crane system for handling the object based on the object properties. For example, the control unit causes the crane system to pick and drop an object in separate areas based on the quality of the object thereby, categorizing the objects. In another example, the control unit causes the crane system to not pick the object when a presence of a human is detected in proximity of the object.

Also disclosed herein, is a computing unit having an artificial neural network for managing a crane system.

According to an embodiment of the present disclosure, the computing unit is deployable in a cloud computing environment and is capable of communicating with the crane system. As used herein, “cloud computing environment” refers to a processing environment comprising configurable computing physical and logical resources, for example, networks, servers, storage, applications, services, etc., and data distributed over the cloud platform. The cloud computing environment provides on-demand network access to a shared pool of the configurable computing physical and logical resources.

According to another embodiment of the present disclosure, the computing unit is deployable in an industrial environment, where the crane system is physically located, as an edge device capable of communicating with one or more crane systems. According to this embodiment, the computing unit comprises a processor, a memory unit, a network interface, and/or an input/output unit to function as an edge device. For example, in order to function as an edge device, the aforementioned hardware components of the computing unit are deployed in the industrial environment in operable communication with the crane system(s), and the data, that is, images collected from the cameras mounted on the crane system, are communicated via the network interface to a cloud-based server wherein the artificial neural network is stored for processing the images thus received for managing the crane system. Moreover, according to this embodiment, there may exists more than one computing units as edge devices deployed in the industrial environment and the edge devices may communicate with one another for managing one or more crane systems simultaneously. According to this embodiment, the computing units may share the processing loads therebetween while managing the crane systems.

According to yet another embodiment, the computing unit is deployable in a distributed architecture where parts of the computing unit are deployable in the industrial environment in proximity of the crane system(s) as an edge device and parts of the computing unit are deployable in the cloud computing environment.

The computing unit disclosed herein may comprise one or more software modules such as a data acquisition module for receiving the image data stream from the cameras, a data processing module for processing the image data stream, and a data analytics and management module for analyzing the image data stream with the artificial neural network and for causing the crane system to handle the object. However, it will be appreciated by a person skilled in the art, that the functionalities offered by each of these modules may be combined into a single module.

The computing unit analyzes an image data stream generated based on the images with help of the artificial neural network and determines object properties associated with the object based on the analysis of the image data stream, wherein the object properties comprise at least a quality of the object.

Also disclosed herein is a method for managing a crane system capable of handling, for example, physically displacing such as lifting, picking, dropping, loading, unloading, etc., an object. It would be appreciated by a person skilled in the art, that aforementioned managing of the crane system may also be extended to positioning of the crane system in proximity of the object in order to handle the object with maximal accuracy and with minimal effort. The object being an industrial object in an industrial environment handled by a crane system, for example, a hoist of the crane system. In embodiments, the method comprises generating an image data stream based on a plurality of images of the object captured by cameras, arranged at predefined positions and/or angles, of the crane system. In embodiments, the method receives the plurality of images from the cameras and pre-processes the images to form an image data stream. It would be appreciated by a person skilled in the art, that the image data stream may even have a single high-resolution image. In embodiments, the method preprocesses each of the images captured by the cameras by reducing noise in the images and/or enhancing contrast of the images. In embodiments, the method determines from the images a foreground associated with the object and annotates the foreground from the images, for example, by applying markers on the foreground of the image.

In embodiments, the method analyzes the image data stream by employing a computing unit of the crane system using an artificial neural network. In embodiments, the method analyzes the image data stream to detect presence of defect(s) in the object by segmenting the images, that is the annotated images, based on the artificial neural network, for example, an artificial neural network trained for identifying markers from an image data stream corresponding to the various object properties of various objects. In embodiments, the method identifies markers in the images corresponding to defects in the object such that a distance between the markers corresponds to an extent of the defects in the object.

According to an embodiment, the method analyzes the image data stream by employing a computing of the crane system using the artificial neural network to detect presence of a human in proximity of the object from the image data stream. In embodiments, the method segments the images, that is the annotated images, based on the artificial neural network and identifies markers in the images corresponding to humans, wherein a distance between the markers corresponds to a proximity of the human with respect to the object.

In embodiments, the method determines by employing the computing unit, object properties associated with the object based on the analysis of the image data stream, wherein the object properties comprise at least a quality of the object. The quality of the object is based on the presence of defect(s) in the object.

According to an embodiment, the method positions the crane system based on the quality of the object. For example, the crane system may be positioned so as to handle the object(s) of a certain predefined quality at a given time instant. In embodiments, this expedites sorting of the objects.

In embodiments, the method automatically operates the crane system for handling the object based on the object properties. In embodiments, the method operates the hoist of the crane system in order to handle the object based on predefined handling parameters defined based on the object properties during training the artificial neural network. The predefined handling parameters include predefined actions to be performed by the hoist including, for example, pick, drop, load, unload, etc., movement of the gantry of the crane system, etc., based on the object properties. In embodiments, controlling of at least one working parameter of the hoist and/or the crane system depends on positions of markers in the images of the image data stream. For example, if a distance between the markers in an annotated image having a defect is greater than a predefined defect threshold for the object, then the crane system is automatically made to pick the object and drop the object at a predefined location, thereby sorting the object out. Such a predefined threshold is available in the trained artificial neural network. In another example, if a distance between the markers in an annotated image corresponds to a minimum distance indicating a human being in proximity of the object, then the crane system is automatically stopped from moving the object. Such a minimum distance is available in the trained artificial neural network.

Also disclosed herein is a method for training the artificial neural network. In embodiments, the training of the untrained artificial neural network is required to be performed only once so as to enable the trained artificial neural network to identify markers from an image data stream. In embodiments, the method generates a training image data stream by obtaining the images of the object, in an industrial environment, and of surroundings of the object, the object being illuminated at predefined angles by illumination source(s) of the crane system, captured by cameras of the crane system. In embodiments, the method extracts, that is scales and balances, using the artificial neural network, from the images of the training image data stream, the object properties associated with the object and surroundings data associated with the surroundings of the object, based on reference images of the object and the surroundings stored in a memory unit accessible to the artificial neural network. As used herein surroundings data refers to data associated with surroundings of the object and comprises, for example, data of humans when present in proximity of the object. Also used herein, reference images of the object include multiple images with and without the object, with and without defects in the object, with and without humans in proximity of the object, etc. In embodiments, the method generating a training database comprising the object properties and the surroundings data for training the artificial neural network. In embodiments, the artificial neural network is trained using a supervised deep learning method for identifying remaining useful life of the object and an unsupervised deep learning method for identifying defect in the object.

Also disclosed herein is a computer program product (non-transitory computer readable storage medium having instructions, when executed by a processor, perform actions) that stores computer program codes comprising instructions executable by at least one processor of the aforementioned computing unit for managing the crane system capable of handling an object.

The computer program codes comprise instructions for performing the aforementioned method for managing the crane system.

The above summary is merely intended to give a short overview over some features of some embodiments and implementations and is not to be construed as limiting. Other embodiments may comprise other features than the ones explained above.

### BRIEF DESCRIPTION

Some of the embodiments will be described in detail, with reference to the following figures, wherein like designations denote like members, wherein:

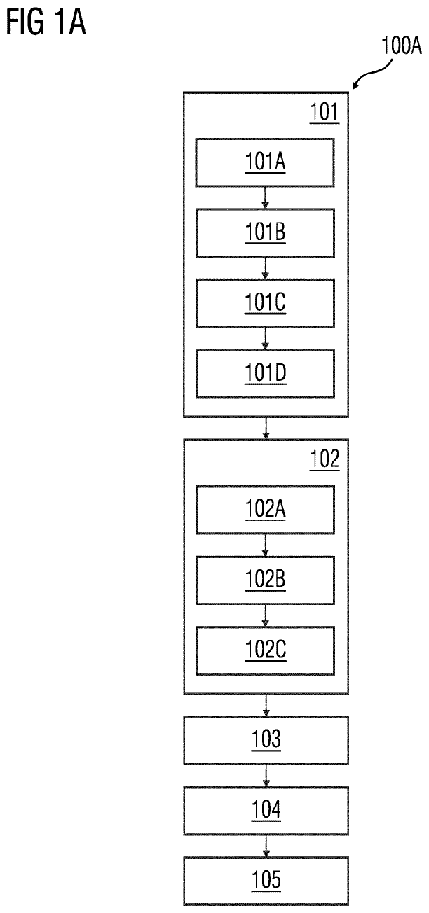

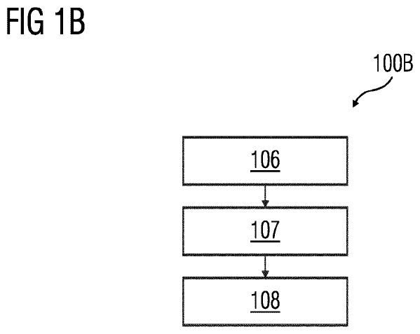

FIG. 1A illustrates a process flow chart of a method for managing a crane system, according to an embodiment of the present disclosure;

FIG. 1B illustrates a process flow chart of a method for training an artificial neural network capable of identifying markers from an image data stream, according to an embodiment of the present disclosure;

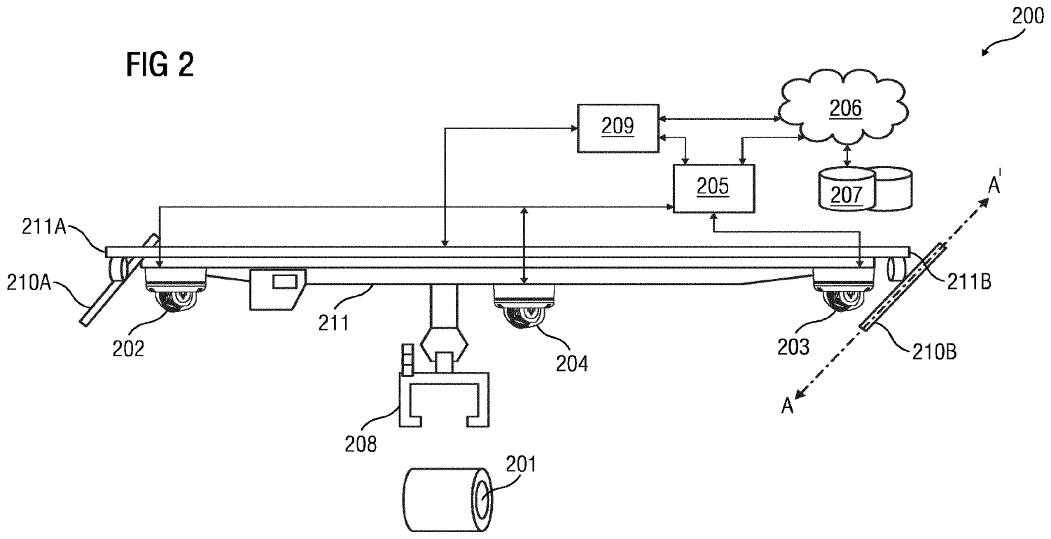

FIG. 2 illustrates a crane system capable of handling an object in an industrial environment, according to an embodiment of the present disclosure;

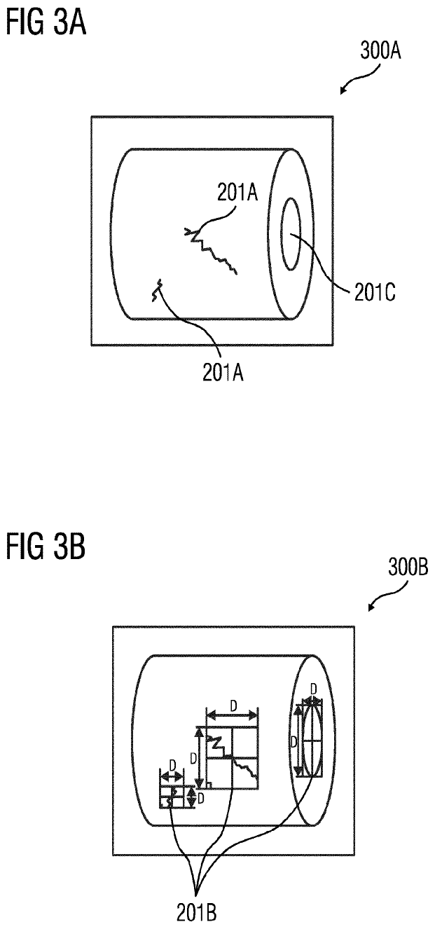

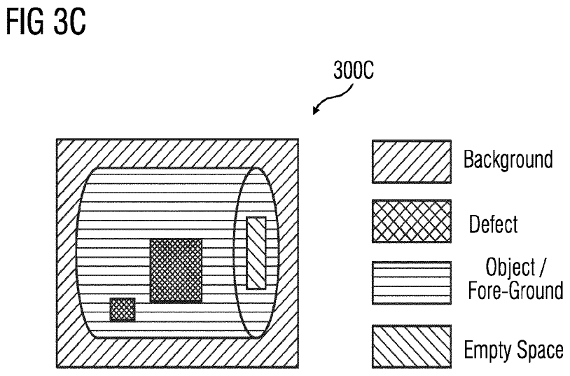

FIG. 3A illustrates an image of an object analyzed by the computing unit shown in FIG. 2, according to an embodiment of the present disclosure;

FIG. 3B illustrates an image of the object analyzed by the computing unit shown in FIG. 2 according to an embodiment of the present disclosure;

FIG. 3C illustrates an image of the object analyzed by the computing unit shown in FIG. 2 according to an embodiment of the present disclosure; and

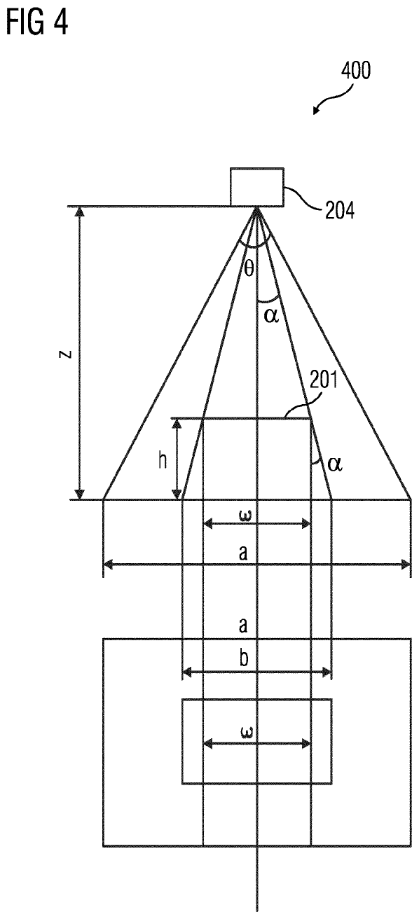

FIG. 4 illustrates a representation of the object being captured by one of the cameras of the crane system shown in FIG. 2 according to an embodiment of the present disclosure.

### DETAILED DESCRIPTION

In the following, embodiments of the disclosure will be described in detail with reference to the accompanying drawings. It is to be understood that the following description of embodiments is not to be taken in a limiting sense.

The drawings are to be regarded as being schematic representations and elements illustrated in the drawings, which are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

FIG. 1A illustrates a process flow chart 100A of a method for managing a crane system, according to an embodiment of the present disclosure. In embodiments, the method employs a trained artificial neural network and/or a computing unit of the crane system for managing the crane system capable of handling an object in an industrial environment.

In embodiments, the method, at step 101, generates an image data stream based on plurality of images of the object captured by cameras of the crane system. The image data stream being a processed image data stream having processed images that can be interpreted accurately by a trained artificial neural network which the computing unit employs.

At step 101A, the method receives the images captured by the cameras either directly from the cameras or from the crane system that may have a memory unit or a database into which the images are temporarily stored.

At step 101B, the method preprocesses each of the images captured by the cameras. The preprocessing comprises cropping the images, reducing noise in the images and/or enhancing contrast and/or brightness of the images. The image preprocessing is required due to the intensity variations, low contrast and a high rate of noise in images that may be captured, for example, using low resolution web cameras. At first, a median filter is applied to the images for noise reduction. After noise reduction, an adaptive histogram equalization is performed on the images for contrast enhancement, considering exponential distribution of histogram. Even though, adaptive histogram equalization provides improvement of the image contrast with no destructive effects on the areas with higher contrast, it may increase the noise on the image. As a result, after adaptive histogram equalization, a median filter is reapplied on the images to reduce the noise, if added any.

At step 101C, the method determines from the images a foreground associated with the object. The foreground may be determined by a variety of image processing techniques including a simple background subtraction, a global grey-level or gradient thresholding or segmentation, statistical classification and/or color classification. The foreground thus determined enables the method, and in turn the trained artificial neural network to identify objects in the images. For example, a steel coil on a factory floor of a steel plant, a human in proximity of the steel coil, etc.

At step 101D, the method annotates the foreground(s) from the image. The method applies image mask(s) for annotating the foreground(s) from the image.

At step 102, the method analyzes the image data stream by employing the computing unit using the trained artificial neural network. In embodiments, the method analyzes the image data stream to detect, one or more abnormalities from the image data stream. The abnormalities include, for example, presence of defect(s) in the object, presence of a human in proximity of the object, etc.

At step 102A, the method segments the images based on the trained artificial neural network. Image segmentation plays a crucial role in identifying abnormalities from the image. The artificial neural network is trained, for example, with deep learning based unsupervised and supervised segmentation techniques using U-Net architecture, described in the detailed description of FIG. 1B. The image segmentation yields cluster labels as an output wherein a label is assigned to each pixel in the image such that pixels with the same label are connected with respect to some visual or semantic property.

At step 102B, the method identifies a distance between markers in the images. The markers are available from the annotated images. The markers represent visual indications applied to the foreground(s) in the image that define the area of the foreground therewithin. The distance between the markers indicates a length of the foreground, a width of the foreground, an area of the foreground, etc.

At step 102C, the method determines based on the distance presence of the abnormalities associated with the object. The distance corresponds to an extent of the defect, a level of proximity of a human with respect to the object, etc. The artificial neural network is trained such that it is capable of identifying, based on the distance between the markers, the abnormalities associated with the object.

At step 103, the method determines object properties associated with the object based on the analysis of the image data stream. The object properties comprise at least a quality of the object. The quality of the object is associated with the abnormalities such as presence of defect(s) in the object. The quality of the object may also be associated with a remaining useful life of the object which a derivable based on the extent of the defect in the object, size of the object, weight of the object, average life of the object, etc. The object properties may also comprise, a position, an orientation, physical dimensions, etc., of the object.

At step 104, the method automatically operates the crane system for handling the object based on the object properties. In embodiments, the method operates the hoist of the crane system for handling the object based on predefined handling parameters used in training the artificial neural network. The predefined handling parameters include a set of actions such as pick, drop, stall, etc., mapped to the object properties. For example, if there exists a quality issue with the object then the hoist is made to pick up the object and drop it at a specified location so as to sort the defective object. In embodiments, the method automatically operates the crane system by controlling at least one working parameter of the hoist and/or the crane system depending on positions of markers in the images of the image data stream, that is, the distance between the markers and therefore, the object properties derived therefrom which are used to train the artificial neural network.

At step 105, the method stores into a database or a memory unit of the crane system the images received from the cameras, the image data stream generated using processed images, the segmented images, the annotated images, the distances between the markers, and/or the object properties. These stored values may in turn be used by the trained artificial neural network to continuously enhance the identification of markers from the images thereby leading to an improved quality assessment of the object and an effective and efficient management of the crane system based on the object properties.

FIG. 1B illustrates a process flow chart 100B of a method for training an artificial neural network, that is an untrained artificial neural network, capable of identifying markers from an image data stream as disclosed in the detailed description of FIG. 1A, according to an embodiment of the present disclosure.

At step 106, the method generates a training image data stream by obtaining the images of the object and of surroundings of the object, for example as much as allowed by a field of view of each of the cameras of the crane system, illuminated at predefined angles by illumination source(s) of the crane system. The training image data stream includes multiple images with and without the object in the field of view, with and without the same object in the field of view, with and without multiple objects in the field of view, with and without human(s) in proximity of the object in the surroundings, etc.

At step 107, the method extracts using the untrained artificial neural network, from the images of the training image data stream, the object properties associated with the object and surroundings data associated with the surroundings of the object (201), based on reference images of the object and the surroundings. In embodiments, the method scales and balances the images and extracts the object properties such as defects in the object, remaining useful life of the object, and/or weight, size, physical dimensions, orientation, etc. of the object. The surroundings data includes other objects that are usually found in and around the object such as conveyor belts, factory floor markings, humans, etc. The reference images are pre-labelled and are fed to the artificial neural network for learning purposes. For example, these reference images may be labelled with the object, the defects in the object, a human in proximity of the object, etc. It would be appreciated by a person skilled in the art that while training the artificial neural network, the labeling of reference images is performed as a one-time activity. This allows the trained artificial neural network to automatically identify markers from an image data stream without the need to re-label the images captured.

At step 108, the method generates a training database comprising the object properties and the surroundings data for training the artificial neural network. The training database may also include predefined handling parameters for the crane system that enable the method disclosed in FIG. 1A to automatically operate the crane system based on the object properties.

The untrained artificial neural network is a Convolutional Neural Network (CNN) that may include a Pyramid Scene Parsing network (PSPnet) with CNN, so as to capture both local and global information along with spatial information of an image, thereby enabling the crane system handling the object to determine not only defects in the object but also remaining useful life of the object.

The artificial neural network is trained using machine learning methods such as a supervised deep learning method for estimating the remaining useful life and/or an unsupervised deep learning method for identifying abnormalities such as presence of a defect in the object. For example, a swish-ReLu activation function is used together with PSP-net and CNN for estimating remaining useful life to increase the smoothness of the learning curve of the artificial neural network. This helps to optimize and generalize the artificial neural network and therefore, the training becomes faster which leads to less CO2 emissions. In embodiments, the method disclosed herein employs a central processing unit (CPU) and not a graphics processing unit (GPU) thereby, being easy to be deployed in any industrial environment and also being economical.

In an example used for training the artificial neural network, the unsupervised deep learning method computes a d-dimensional feature map {am} from three different image planes {um} including, for example, the RGB image planes, through the N convolutional module, the swish ReLU activation function, and a batch normalization function, where a batch corresponds to M pixels of a single input image from the training image data stream. The batch normalization is used for generating a feature map {ym} before assigning cluster labels via argmax classification into the deep learning architecture used. Next, a large margin soft-max loss between the network responses {ym′} and the refined cluster labels {cm′} is calculated. Next, the error signals are backpropagated to update the parameters of convolutional filters {wtm,bm}Mm=1 as well as the parameters of the classifier {wtc,bc}. Here, a stochastic gradient descent with momentum is used for parameter up-dation. In embodiments, setting the learning rate of the artificial neural network to 0.1 (with a momentum of 0.9) yields optimal learning results.

The identification of age or remaining useful life is correlated to the object properties. The determination of these object properties is carried out by image processing and deep learning techniques. Thus, rapid, intelligent, and non-destructive techniques are required in training of the artificial neural network. In embodiments, the method formulates calculation of the remaining useful life of an object from an image as a classification problem, for example, each new image from the training image data stream is classified into a class from classes 1-N such that each class corresponds to a time duration indicating the remaining useful life. Basically, the convolutional neural network (CNN) is used for distinguishable feature representation of an image with age information and is trained on those features, including visual and non-visual features, with support vector machine. Furthermore, the CNN's output layer also known as a probability layer consists of ‘n’ number values for ‘n’ age classes such as “1-10 units of time”, “11-20 units of time”, and so on.

The identification of defects from an image heavily relies on an external appearance of the object as available in the image, especially when applied to quality inspection and defect sorting applications such as sorting of steel coils based on their quality. Image segmentation, that is, a process of assigning a label to each pixel in the image such that pixels with the same label are connected with respect to some visual or semantic property, plays a central role in identifying defects from image. In embodiments, the method for training the artificial neural network to identify markers in an image and derive whether or not there exists a defect in the object, employs unsupervised segmentation techniques using U-Net architecture.

The problem formulation that is solved for image segmentation is represented using below equation

$$\{ a\_m ∈ R \hat{} q \} \_ ( m = 1 ) \hat{} M \qquad ( 1 )$$

for a set of q dimensional feature vectors of image pixels, where M denotes the number of pixels in an input image.

The cluster labels used for segmentation are represented using the equation given below

$$\{ c\_m ∈ Z \} \_ ( m = 1 ) \hat{} M \qquad ( 2 )$$

The labels are assigned to all of the pixels by representing a mapping function given below

$$c\_m = f ( a\_m ) where f : R\_ ( q ) \to Z \qquad ( 3 )$$

Here, f returns the number of the cluster centroid which is nearer to a_m (using k-means clustering) among k centroids. Therefore, in an unsupervised technique, c_m can be derived/predicted using fixed value of f and a_m whereas in a supervised technique, f and a_m are trainable and c_m are fixed. However, f and a_m can be optimized using different optimization like stochastic gradient descent etc. Therefore, spatially continuous pixels of similar features are desired to be assigned the same label.

In embodiments, the method assigns the same label to pixels of similar features. Next, linear classifier is applied that classifies the features of each pixel into d classes.

Let's assume, for an RGB image

$$I = \{ u\_ ( m ) ϵ R \hat{} 3 \} \_ ( m = 1 ) \hat{} M \qquad ( 4 )$$

after image normalization. A d-dimensional feature map {a_m} is computed from three different image planes {u_m} through N convolutional module, swish ReLU activation function, and a batch normalization function, where a batch corresponds to M pixels of a single input image. Here, q filters of region size 3×3 for all the N components are set. Next, a mapping function is obtained by applying a linear classifier

$$\{ 〚 y\_m = wt 〛 \_ca \_m + b\_c \} \_ ( m = 1 ) \hat{} M where 〚 wt 〛 \_ ( c ) ϵ R \hat{} ( d \times q ) and b\_c ϵ R \hat{} d . \qquad ( 5 )$$

The response map to {y_m\hat{ }′} is normalized such that {y_m\hat{ }′}_(m=1)\hat{ }M has mean (=0) and variance (=1). Finally, the cluster label c_m is obtained for each pixel by selecting the dimension that has the maximum value in y_m\hat{ }′. This type of classification is referred as argmax classification. To make it more meaningful, an additional constraint that supports cluster labels that are the same as those of adjacent pixels is added.

First, L fine super pixels {S_1}_(l=1)\hat{ }L (with a large L) from the input image I are extracted, where S_1 denotes a set of the indices of pixels that belong to the 1-th super pixel. Then, all of the pixels in each super pixel are assigned to have the same cluster label. Here, simple minimum spanning tree based iterative clustering is used with L (=32) for the super pixel extraction.

Selecting the number of cluster labels (d) in an unsupervised image segmentation is a challenging task. As describe above, the strategy is to classify pixels into random number d\hat{ }′ (1≤d\hat{ }′≤d) of clusters. The large and small values of d\hat{ }′ indicates over and under segmentation. To prevent this kind of under segmentation failure a batch normalization is incorporated (where a batch corresponds to M pixels of a single input image) for generating feature map {y_m} before assigning cluster labels via argmax classification into the used deep learning architecture.

In embodiments, the method auto-trains the artificial neural network for unsupervised image segmentation in the following manner. Once a target image, that is an image of the object, is input, there are two alternatives namely prediction of cluster labels with fixed network parameters which corresponds to the forward process of a network followed by the super pixel refinement described above and/or training of network parameters with the fixed cluster labels which corresponds to the backward process of a network based on gradient descent. As with the case of supervised learning, the method calculates the large margin soft-max loss between the network responses {y_m\hat{ }′} and the refined cluster labels {c_m\hat{ }′}. Next, the method backpropagates the error signals to update the parameters of convolutional filters { [symbol] wt [symbol] _m,b_m}_(m=1)\hat{ }M as well as the parameters of the classifier { [symbol] wt [symbol] _c,b_c} using stochastic gradient descent with momentum for parameters up-dation.

The artificial neural network trained in aforementioned manner not only allows computation of abnormalities, that is, defects in the object but also remaining useful life and has the ability to add more features in future as required. PSPnet with CNN, helps to capture both local and global information of an image which enables to find the remaining useful life along with defects present if any in the object from its images.

FIG. 2 illustrates a crane system 200 capable of handling an object 201 in an industrial environment, according to an embodiment of the present disclosure. The crane system 200 comprises a hoist 208 for moving the object 201, for example, a steel coil in a steel plant. The crane system comprises cameras 202, 203, and 204 positioned at predefined positions and at predefined angles of capture so as to capture high-definition, real time images of the object 201. The camera 202 is arranged at a first end 211A of a gantry 211 of the crane system 200. The camera 203 is arranged at a second end 211B of the gantry 211 and the camera 204 is arranged in proximity of the hoist 208 on the gantry 211.

The crane system 200 comprises a control unit 209. The control unit 209 moves the cameras 202, 203, and 204, for capturing the images of the object 201, along a longitudinal axis A-A′ of gantry tracks 210A, 210B.

The crane system 200 comprises a computing unit 205 in operable communication with the control unit 209 via a wired or a wireless communication network 206. The computing unit 205 may also communicate with the cameras 202, 203, and 204 via the wired or a wireless communication network 206. The computing unit stores therein the artificial neural network.

The crane system 200 comprises a training database 207. The artificial neural network accesses the training database to train itself for identifying markers in the images of the object 201 and determined object properties therewith. The training database may also store therein the images captured by the cameras 202, 203, and 204.

FIGS. 3A-3C illustrate images 300A, 300B, 300C of an object 201 analyzed by the computing unit 205 shown in FIG. 2, according to embodiments of the present disclosure.

FIG. 3A shows an image 300A of the object 201 captured by one or more of the cameras 202, 203, 204. The image 300A may also represent an image collated based on individual images captured by each of the cameras 202, 203, 204. As shown in FIG. 3A, the object 201 which is a steel coil has defects, that is, cracks 201A.

FIG. 3B shows an image 300B that is pre-processed, segmented, and annotated by the computing 205 based on the trained artificial neural network. The image 300B shows annotations around the object 201, that is the steel coil, as a whole and around each of the areas in the image 300B that differ significantly from other areas in the image 300B, for example, the cracks 201A and the center 201C of the coil which is an empty space at the center of the steel coil roll. The computing unit 205 based on the trained artificial neural network identifies markers 201B on each of the aforementioned areas. The computing unit 205 based on the trained artificial neural network then identifies a distance ‘D’ between each of these markers and thereafter presence of a defect in the object 201.

FIG. 3C shows an image 300C that is an image as seen by the trained artificial neural network wherein the foreground that is the steel coil, the background that is the surrounding of the steel coil, the defects that is the cracks 201A, and/or a non-defect area such as an empty space at the center 201C of the steel coil are clearly differentiated.

Based on the above derivations, that is a presence of a defect in the object 201, and predefined handling parameters used in training of the artificial neural network, the computing unit 205 via the control unit 209 causes the hoist 208 of the crane system shown in FIG. 2 to handle the object 201.

FIG. 4 illustrates a representation of the object 201 being captured by one of the cameras 204 of the crane system 200 shown in FIG. 2. The camera 204 is positioned on the gantry in proximity of the hoist 208 as shown in FIG. 2. The camera 204 is positioned at a height ‘Z’ from the ground level on which the object 201 is positioned. The camera has an angle of capture θ. The computing unit 205 based on the images captured by the camera 204 and the cameras 202 and 203 determines a size of the object, that is, a height ‘h’, a width ‘w’, and a breadth ‘b’ as shown in FIG. 4. The computing unit 205 determines the width ‘w’ based on images captured by the cameras 202 or 203. The breadth ‘b’ is determined based on the images captured by the camera 204. Afield of view ‘a’ and the height ‘h’ are determined as explained in the equations provided below:

$$a = 2 * Z * tan ( ⊖ / 2 )$$

$$tan ∝ = b / 2 Z = ( ( ( b - w ) / 2 ) ) / h$$

$$therefore , h = [ ( ( ( b - w ) ) / 2 ) / ( b / 2 Z ) ]$$

$$and therefore , h = ( b - w ) Z / b$$

Where ∝ is angle of capture of the camera 204.

Thus, the cameras 203, 203, and 204 captured images of the object 201 so as to enable the computing unit 205 to determine physical dimensions of the object, an orientation of the object and thereby, defects associated with the object with help of the trained artificial neural network.

Where databases are described such as the training database 207, it will be understood by one of ordinary skill in the art that (i) alternative database structures to those described may be readily employed, and (ii) other memory structures besides databases may be readily employed.

Any illustrations or descriptions of any sample databases disclosed herein are illustrative arrangements for stored representations of information. Any number of other arrangements may be employed besides those suggested by tables illustrated in the drawings or elsewhere.

Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present disclosure can be configured to work in a network environment comprising one or more computers that are in communication with one or more devices via a network. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, some examples of which are disclosed above, that are adapted to communicate with the computers. In an embodiment, each of the computers is equipped with a network communication device, for example, a network interface card, a modem, or other network connection device suitable for connecting to a network. Each of the computers and the devices executes an operating system, some examples of which are disclosed above. While the operating system may differ depending on the type of computer, the operating system will continue to provide the appropriate communications protocols to establish communication links with the network. Any number and type of machines may be in communication with the computers.

The present disclosure is not limited to a particular computer system platform, processor, operating system, or network. One or more aspects of the present disclosure may be distributed among one or more computer systems, for example, servers configured to provide one or more services to one or more client computers, or to perform a complete task in a distributed system. For example, one or more aspects of the present disclosure may be performed on a client-server system that comprises components distributed among one or more server systems that perform multiple functions according to various embodiments. These components comprise, for example, executable, intermediate, or interpreted code, which communicate over a network using a communication protocol. The present disclosure is not limited to be executable on any particular system or group of systems, and is not limited to any particular distributed architecture, network, or communication protocol.

The foregoing examples have been provided merely for the purpose of explanation and are in no way to be construed as limiting of the present disclosure disclosed herein. While the disclosure has been described with reference to various embodiments, it is understood that the words, which have been used herein, are words of description and illustration, rather than words of limitation. Further, although the disclosure has been described herein with reference to particular means, materials, and embodiments, the disclosure is not intended to be limited to the particulars disclosed herein; rather, the disclosure extends to all functionally equivalent structures, methods and uses, such as are within the scope of the appended claims. Those skilled in the art, having the benefit of the teachings of this specification, may affect numerous modifications thereto and changes may be made without departing from the scope of the disclosure in its aspects.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for managing a crane system capable of handling an object, the method comprising:
generating an image data stream based on a plurality of images of the object captured by cameras the crane system;
analyzing the image data stream by employing a computing unit of the crane system using an artificial neural network, wherein the artificial neural network is trained for identifying markers from the image data stream;
determining, by the computing unit, object properties associated with the object based on the analysis of the image data stream, wherein the object properties comprise at least a quality of the object; and
automatically operating the crane system for handling the object based on the object properties.

2. The method according to claim 1, wherein generating the image data stream comprises performing:
preprocessing each of the images captured by the cameras, wherein preprocessing comprises one or more of reducing noise in the images and enhancing contrast of the images;
determining from the images a foreground associated with the object; and/or
annotating the foreground from the images.

3. The method according to claim 1, wherein analyzing the image data stream using the artificial neural network comprises detecting, from the image data stream, presence of one or more abnormalities associated with the object, and wherein the abnormalities comprise one or more of a defect in the object and a human in proximity of the object.

4. The method according to any one of the claim 1, wherein analyzing the image data stream using the artificial neural network comprises:
segmenting the images based on the artificial neural network;
identifying a distance between markers in the images; and
determining, based on the distance and the segmented images, presence of the abnormalities.

5. The method according to claim 1, wherein automatically operating the crane system comprises operating a hoist of the crane system for handling the object based on predefined handling parameters defined based on the object properties during training of the artificial neural network.

6. The method according to claim 5, further comprising controlling at least one working parameter of one of the hoist and the crane system depending on positions of markers in the images of the image data stream.

7. A method for training the artificial neural network, according to claim 1, for identifying markers from an image data stream, comprising:
generating a training image data stream by obtaining the images of the object and of surroundings of the object, illuminated at predefined angles by one or more illumination sources of the crane system, captured by cameras of the crane system;
extracting using the artificial neural network, from the images of the training image data stream, the object properties associated with the object and surroundings data associated with the surroundings of the object, based on reference images of the object and the surroundings; and
generating a training database comprising the object properties and the surroundings data for training the artificial neural network.

8. A crane system capable of handling an object, comprising:
cameras positioned to capture a plurality of images of the object;
a computing unit having an artificial neural network configured to:
analyze an image data stream generated based on the images using an artificial neural network; and
determine object properties associated with the object based on the analysis of the image data stream, wherein the object properties comprise at least a quality of the object; and
a control unit configured to automatically operate a hoist of the crane system for handling the object based on the object properties.

9. The crane system according to claim 8, wherein the control unit is configured to move the cameras, for capturing of the images of the object, along an axis of gantry tracks.

10. The crane system according to claim 8, comprising a first camera arranged at a first end of a gantry of the crane system, a second camera arranged at a second end of the gantry, and a third camera arranged in proximity of the hoist on the gantry.

11. A computing unit having an artificial neural network for managing a crane system, according to claim 8.

12. A computer program product comprising a computer readable hardware storage device having computer readable program code stored therein, said program code executable by a processor of a computer system to implement the method according to claim 1.
